(19) United States
(12) Patent Application Publication
(10) Pub. No.: US 2004/0000653 A1
(43) Pub. Date: Jan. 1, 2004

(54) Method and device for spectrophotometric analysis

(76) Inventor: Bengt Nordlund, Rydeback (SE)

Correspondence Address: HARNESS, DICKEY & PIERCE, P.L.C., P.O. BOX 8910, RESTON, VA, 20195, US

(21) Appl. No.: 10/283,169

(22) Filed: Oct. 30, 2002

(30) Foreign Application Priority Data
Jun. 26, 2002 (SE) 0201970-1

(51) Int. Cl. G01N 15/06; G01N 21/49

(52) U.S. Cl. 250/573

(57) ABSTRACT

The present invention provides a method for spectrophotometric analysis of a beverage, which method comprises analyzing the beverage while contained in a closed end consumer container. The present invention also provides a device for analyzing a beverage that comprises an analyzing means for analyzing the beverage while contained in a closed end consumer container. The analyzing means comprises a detector arranged for detecting electromagnetic radiation which has been transmitted through the beverage.

The present application hereby claims priority under 35 U.S.C. §119 on Swedish patent application number SE 0201970-1 filed Jun. 26, 2002, the entire contents of which are hereby incorporated herein by reference.

### TECHNICAL FIELD OF THE INVENTION

This invention generally relates to a method for analysis of a beverage. The invention also generally relates to a device for analyzing a beverage.

### BACKGROUND OF THE INVENTION

Analysis of beverages is made for verifying the quality of the beverages. While the quality is very important for the producers of the beverage, it is still desirable that the analysis is efficient and fast.

One method for analysis of a beverage is known as “in-line”-analysis. This method is carried out by analyzing the beverage while contained in a conveying tube during the production of the beverage. Since this method analyzes the beverage during the production the analysis result does not necessarily reflect the quality of the final product. The quality of the beverage may still be affected before the final product is completed. Thus, there is still a need to analyze the actual final product.

The most common way of analyzing a beverage in its final stage today is carried out by first selecting a closed container, which is intended for an end consumer and which contains the beverage from a production line. The selected container holds a sample of the produced beverage. The analysis of the beverage is achieved by opening the closed container, pouring the beverage into a sample holder, such as a cuvette and then analyzing the beverage. The analysis may be performed spectrophotometrically or by another method.

This process is inefficient and time consuming, especially if the closed container holds a pressurizing gas. In such cases the pouring will give rise to spume, which will disturb the analysis, and which has to disappear before analysis can be carried out. Therefore, a long time is required in order to get a sufficient analysis of the beverage.

Also, since the beverage is poured out of its closed end-consumer container it is unusable after analysis, and therefore it cannot be put back in the production line. Consequently, the beverage that is analyzed is wasted, whereby the cost for producing the beverage increases.

### SUMMARY OF THE INVENTION

It is an object of an embodiment of the invention to provide a more efficient and less time-consuming analysis of a beverage.

It is another object of an embodiment of the invention to provide an analysis that reduces waste, and thereby effectively use all beverage that is produced.

The objects of an embodiment of the invention are achieved by a method for spectrophotometric analysis of a beverage, by analyzing the beverage while contained in a closed end consumer container. Thereby, the beverage contained in the closed container is spectrophotometrically analyzed.

The objects of an embodiment of the invention are also achieved by a device for analyzing a beverage, comprising an analyzing means for analyzing the beverage while contained in a closed end consumer container. The analyzing means comprises a detector arranged for detecting electromagnetic radiation which has been transmitted through the beverage.

As a result of an embodiment of the invention, the beverage may be analyzed when packaged in its container intended for distribution to a customer. Further, the analysis may be performed without wasting any beverage through the analysis. Also, the analysis may be performed quickly, since there is no need for opening the container and preparing a sample. Thus, the closed container can be selected and then the beverage therein may be analyzed immediately. Thanks to this, the beverage is kept in the closed container throughout the entire analysis making it possible to repeat the analysis on the same container, i.e. analyze the same beverage more than one time. The possibility to repeat the analysis implies that if an error occurs during analysis, the analysis may be repeated without the need for taking out a new container from the production line. Further, there is also a possibility to distribute the beverage in the closed container to a consumer after the beverage in the container has been analyzed. Consequently, there is a reduce in waste of beverage during the analysis. Thanks to the simplicity and the quickness of the analysis the control of the beverage may be performed often and thereby the certainty of the quality of the beverage and the quality of the beverage itself may increase.

In the context of this application, a beverage is a non-alcoholic beverage or an alcoholic beverage, such as mineral water, regular water, lemonade, soda, cider, beer, whiskey, champagne etc. The closed end-consumer container may be a bottle, a can, a liquid foodstuff package, a pouch, a barrel, etc.

According to an embodiment of the inventive method, the step of analyzing the beverage comprises analyzing said beverage in the closed container while said closed container prevails a static equilibrium between a liquid phase and a gaseous phase. The beverage will constitute the liquid phase. Further, the analyzing means may be arranged for analyzing the beverage in the container, while the container prevails the static equilibrium. The static equilibrium may prevail since the container is closed and there is no contact between the contents in the container and air outside the container. Since the static equilibrium prevails, the condition of the contents of the container will not change from the time of analysis until the product reaches a consumer. Further, the analysis will not change the conditions of the contents of the container.

According to another embodiment, the step of analyzing the beverage comprises analyzing said beverage in the closed container which holds a pressurizing gas. Also, the analyzing means may be arranged for analyzing the beverage in the container that holds a pressurizing gas. Since the beverage analyzed is not poured out of the closed container, it will never have contact with the air outside the closed container. This is especially advantageous when the container holds a pressurizing gas, since no spume will be created before or during the analysis. As a result, the beverage in the container may be analyzed directly. This reduces the analysis time, since there is no need to wait until the spume has disappeared.

In the context of this application, a pressurizing gas may be carbon dioxide, nitrogen, etc.

According to yet another embodiment, the step of analyzing the beverage comprises detecting electromagnetic radiation which has been transmitted through the beverage. The step of analyzing the beverage may also comprise irradiating electromagnetic radiation through the beverage. The absorbance of the beverage depends on the contents thereof and since the quality also is dependent of the contents of said beverage the quality may be determined by measuring the absorbance. Since the radiation transmitted through the beverage is an indication of the absorbance it may be used for analyzing the quality of said beverage.

Further, the step of analyzing the beverage may comprise detecting electromagnetic radiation which has been transmitted through said closed container and the beverage therein. The step of analyzing the beverage may also comprise irradiating of electromagnetic radiation through said closed container and the beverage therein. As a result, it will be easier to control the quality of the beverage inside the closed container. In this case, it may be suitable that the container and the beverage have a relatively small absorbance so that a detectable amount of radiation will be transmitted through the container and the beverage without the need for a very strong radiation source.

According to an embodiment, the step of analyzing the beverage may comprise determining an amount of at least one of the constituents of said beverage. The analyzing means may be arranged for determining said amount. By determining the amount the quality according to the constituents of the beverage may be decided. The determined amount is compared with a predetermined amount that corresponds to a certain quality desired. This predetermined amount may specify a range in which the determined amount is to be within.

A constituent for which an amount is to be determined may be ethyl alcohol or any kind of sugar, such as maltose, glucose, saccharose. Any measurable constituents may of course be determined.

According to another embodiment, the step of analyzing the beverage may comprise determining at least one quality parameter. The analyzing means may be arranged for determining the at least one quality parameter. This at least one quality parameter may also be used for deciding the quality of the beverage. Similarly, the quality parameter is compared with a predetermined parameter corresponding to a desired quality. The predetermined parameter may also specify a range in which the determined parameter should be within.

The determined quality parameter of the beverage may e.g. be at least one in the group of viscosity, original gravity and colour.

According to yet another embodiment, the wavelengths of the electromagnetic radiation used in the step of analyzing is within the range of 400 to 2500 nm. These wavelengths are particularly suitable for analysis of a beverage contained in a closed end consumer container, since the absorbance of the closed container for these wavelengths affects the total detected radiation insignificantly. The absorbance of the beverage is also small enough for these wavelengths to make it possible to transmit the radiation along a relatively long path through the beverage, while still receiving detectable amounts of radiation.

Preferably, the wavelengths are within the range of 850 to 1050 nm. These wavelengths are particularly suitable for analysis of parameters and/or constituents in a beverage, since the absorption for these wavelengths is dependent on the contents of the product in a detectable manner. Further, the transmittance of the radiation through the beverage and the closed container is relatively high for these wavelengths.

According to an embodiment, said closed container used in the step of analyzing is formed of a material essentially transparent to electromagnetic radiation having wavelengths within the range of 400 to 2500 nm. This implies that the transmittance of the radiation through the closed container is relatively high for these wavelengths. Thus, the closed container will not affect the amount of transmitted radiation considerably.

Alternatively, the material is essentially transparent for electromagnetic radiation having wavelengths within the range of 850 to 1050 nm.

In the context of this application, the statement that “a material essentially transparent” means a material that transmits the most of incident radiation but may absorb or reflect an insignificant amount of the electromagnetic radiation of wavelengths within a specific range. As a result, a closed container formed of such a material produces a closed container that essentially does not affect the electromagnetic radiation during the analysis.

According to an embodiment of the device according to the invention, said analyzing means comprises an electromagnetic radiation source arranged for irradiating through the beverage. Thus, radiation that is particularly suitable for the analysis of said beverage is provided.

According to another embodiment, said detector is arranged for detecting electromagnetic radiation which has been transmitted through said closed container and the beverage therein. This implies that a simple arrangement of the detector is provided. Thus, no manipulation of the closed container is needed to perform the analysis of the beverage therein.

The analyzing means may comprise an electromagnetic radiation source arranged for irradiating through said closed container and the beverage therein. In this way the wavelengths of the electromagnetic radiation emitted by the source may be adjusted such that sufficient amounts of electromagnetic radiation may be transmitted through the beverage and the closed container in order to enable analysis of the beverage. The intensity of the electromagnetic radiation emitted by the source may also be adjustable to achieve this. As a result, analyzing a beverage in a closed container is easily performed.

The electromagnetic radiation source may emit radiation having wavelengths within the range of 400 to 2500 nm. Thus, the electromagnetic radiation source emits radiation having wavelengths that typically suites the specific beverage being analyzed and that is not essentially affected by the closed container. Preferably, said electromagnetic radiation source may emit radiation having wavelengths within the range of 850 to 1050 nm. These wavelengths are the most suitable wavelengths for analysis of the beverage contained in a closed container.

According to yet another embodiment, the device is arranged in such a manner that said closed container is placeable between the radiation source and the detector for analyzing the beverage in said closed container. Thus, a container holding the beverage to be analyzed may be placed between the source and the detector and thereafter be immediately analyzed. The device will in this manner provide a fast and easy way for analysis. Thus, there is no need for adjusting the measurement setup before the beverage may be analyzed.

According to yet another embodiment, the device comprises a receiving element arranged for receiving said closed container. It may be particularly arranged for accurate placement of an analysis object within the analysis device. According to a specific embodiment, a bottle is used as said closed container and the receiving element is arranged for receiving the bottle.

According to another embodiment, the analyzing means comprises a calculating means arranged for determining different parameters and/or constituents in said beverage. Such a constituent may be e.g. ethyl alcohol, any kind of sugar, such as maltose, glucose, saccharose, while such a parameter may be e.g. viscosity, original gravity or colour. The calculating means may be adapted to process the detected radiation to determine the parameters and the constituents, which in turn determines the quality of the beverage. The processing may comprise substantial calculations and the determining of the quality of the beverage may comprise comparison of the parameters and the constituents with predetermined values according to a calibration.

According to another embodiment, the beverage is beer. The method and device are particularly suitable for analysis of beer.

According to yet another embodiment, the electromagnetic source emits electromagnetic radiation having wavelengths for which the material of the closed container is essentially transparent. This implies that the emitted radiation is not essentially affected by the closed container. Thus, these containers facilitate the analysis of the beverage therein. In other words, the container is transparent for the wavelengths emitted by the electromagnetic radiation source.

### BRIEF DESCRIPTION OF THE DRAWINGS

Other features and advantages of the present invention will become apparent from the following detailed description of a presently preferred embodiment, with reference to the accompanying drawings, which by way of example show embodiments of the invention.

FIG. 1 is a flow chart of a method for analyzing a beverage according to the invention.

FIG. 2 is a schematic view of a device for analyzing a beverage according to the invention.

### DETAILED DESCRIPTION OF A PRESENTLY PREFERRED EMBODIMENT

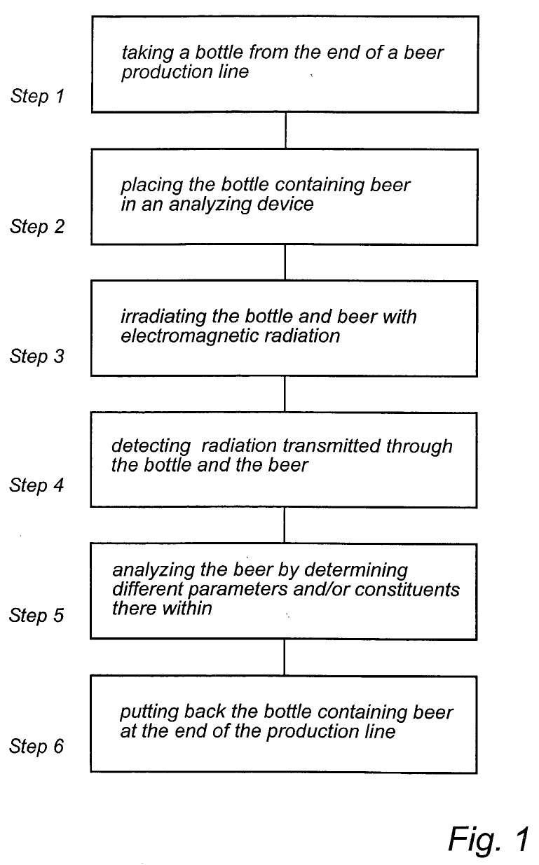

Referring to FIG. 1, a method for analyzing beverage will now be described. The method is implemented at the end of the production line, i.e. when the beverage has been poured into an end consumer container and has been closed to be ready for shipment. The beverage may be beer or other alcoholic beverages, such as cider, champagne, whiskey, etc. However, the beverage may also be a non-alcoholic beverage, such as mineral water, regular water, lemonade, soda, etc. The closed end consumer container may be a bottle. However, the closed container may be any container that is ready to be delivered to a customer, such as a can, a pouch, a liquid foodstuff container, or a barrel. In the following, the beverage is beer and the closed end consumer container is a bottle.

The analyzing is performed on the beer in a bottle, which is taken from the end of the production line, step 1, i.e. the bottle containing beer is the final product reaching the customers. Thus, the analysis is performed on the product which is actually sold. The producer may freely choose how often a bottle should be taken from the production line for analysis of the quality of the beer. For example, every hundredth bottle may be analyzed, or the first and the last bottle produced within a time period or of a certain beverage may be analyzed, etc. It is very common that the brewery devices are cleaned at regular intervals. In order to ensure that there is no remains from the cleaning the producer often wants to analyze the beer in the first bottle produced after cleaning.

Next, the closed container is placed in a device for analysis, step 2. When the bottle has been filled with beer and a pressurizing gas, such as carbon dioxide, in the production line the bottle is capsuled. Then, a static equilibrium is created between the beer and the carbon dioxide. The carbon dioxide is a pressurizing gas which gives rise to spume when pouring the beer out of the bottle. The bottle containing the beer is placed directly into the analyzing device without being opened. Consequently, the bottle prevails the static equilibrium between the beer and the carbon dioxide, and the pressurizing gas does not create any spume before or during the analysis.

When the bottle has been placed in the device the beer is irradiated by electromagnetic radiation having wavelengths within the range of 850 to 1050 nm, step 3, which wavelengths are suitable to use when analyzing beer. Further, the bottles affect the radiation insignificantly at these wavelengths. Thus, the transmittance of the radiation through the bottle is relatively high for these wavelengths. Also, in this wavelength range the absorption of the beer is dependent on the contents of the beer and the amount thereof in a detectable manner. Since the wavelengths are chosen to match the transparency of the bottle so that a sufficient amount of radiation is transmitted, a relatively large analyzing container such as a bottle may be used when analyzing the beer. This implies that the beer does not have to be poured into an analyzing cuvette before the analysis may be performed. Wavelengths within the range of 400 to 2500 nm may be used. For wavelengths outside this range of 400 to 2500 nm, the absorbance of the bottle might affect the transmission so much that it is difficult or even impossible to determine the quality of the beer.

When the irradiation has been transmitted through the beer and the bottle it is detected, step 4. Since the quality of the beer as well as the absorbance is dependent on the contents, the absorbance is a good measure of the quality. The transmission of the radiation through the beer is an indication of the absorbance of the beer, since most of the radiation which is not absorbed by the beer is transmitted through it. Therefore, the detected transmitted radiation is used to determine the quality of the beer. The bottle is essentially transparent in the wavelength range used and does neither affect the transmission and, consequently, nor the determination of the quality. The transmission is detected as a spectrum, the appearance of which depends on the absorbance of the beer.

After detecting the spectrum it is used to analyze the beer, step 5. As mentioned above, the appearance of the spectrum is different depending on the occurrence of different contents and the amounts thereof. Thus, by using the information in the spectrum detected, the amount of ethyl alcohol in the beer may be determined. Different quality parameters in the group of viscosity, original gravity, colour, etc, may also be determined. The amount of ethyl alcohol in the beer is the most common content analyzed in beer, when the quality is determined. However, the other quality parameters may also be useful for the producer. The different parameters are derived from the spectrum by using univariate or multivariate analysis. Univariate or multivariate analysis is a way of applying statistical methods on experimental data and it provides tools to make good use of measured data, enabling practitioners to make sense of measurements and to quan-titatively model and produce visual representations of information. Univariate or multivariate analysis also provides a means of collecting relevant information through statistical experimental design.

After the analysis the bottle is put back at the end of the production line, step 6. Since the bottle is closed throughout the entire analysis, the beer has no contact with the air outside the bottle and is therefore not changed nor affected by the analysis. Thus, after analysis, it is possible to distribute the beer in the analyzed bottle to the customer together with the other unanalyzed bottles. The analysis may also be seen as a repeatable process, since the same beer may be analyzed more than once. This may be desirable in those cases when the first analysis on a bottle was not satisfactory. Then, the same bottle may be placed in the device and analyzed again.

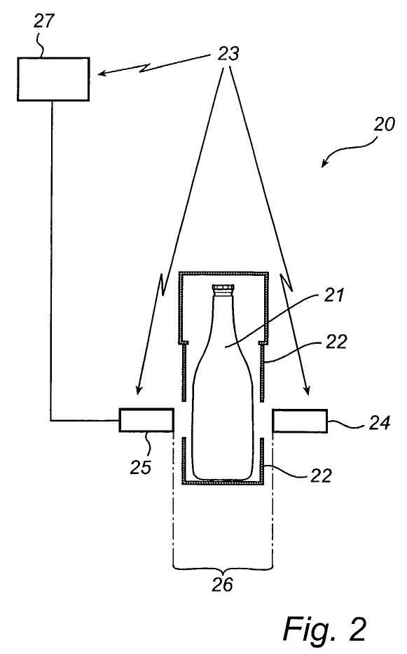

Referring to FIG. 2, a device 20 for analyzing a beverage according to the invention will be described. The device 20 is arranged for analyzing beverage in a closed end consumer container 21. Thus, the device 20 may be arranged to analyze beer in a bottle 21.

The device 20 comprises a receiving element 22, which holds a bottle 21 containing the beer during analysis. Further, the device 20 comprises an analyzing means 23, which in turn comprises an electromagnetic radiation source 24. The radiation source 24 comprises a halogen lamp, that emits wavelengths within the range of 850 to 1050 nm. Further, the radiation source 24 is arranged to irradiate through the bottle 21 and the beer inside it. The wavelengths within this range are suitable to use when analyzing beer in bottles. The intensity of the electromagnetic radiation emitted by the source 24 is also adjusted to be able to irradiate through the beer and the bottle.

The analyzing means 23 also comprises a detector 25 for detecting the electromagnetic radiation transmitted through the bottle 21 and the beer. The detector 25 comprises a detector head (not shown), which collects the radiation. The collected radiation is guided to a spectrometer of the detector, which analyzes the spectral contents of the radiation. The wavelengths of the electromagnetic radiation are spatially separated in the spectrometer. The wavelengths are separated for separate detection of the intensity of different wavelengths. The spatial separation of the wavelengths could be achieved by a dispersive element, such as a grating or a prism, or through principles known as Fourier-Transform (FT) spectroscopy (time domain spectroscopy), in the spectrometer. The dispersive element may be controlled such that one wavelength at a time is directed towards an intensity detector. In this may, a scanning of the dispersive element will give an array of measured intensities of different wavelengths. Alternatively, a fixed dispersive element will disperse the wavelengths and differently positioned intensity detectors will detect radiation of different wavelengths. Thus, an array of separated intensity detectors is arranged for simultaneously detecting the radiation intensity for different wavelengths.

The wavelengths could alternatively be separated before the sample is irradiated. Thus, only a small range of wavelengths will interact with the sample at a time. Then, the wavelengths irradiating the sample are scanned for each sample. A dispersive element is then turned during scanning of the wavelengths to give off different wavelengths. The detector 25 will then only detect the radiation intensity of one small wavelength range at a time. When all wavelengths have been scanned, a transmitted radiation spectrum has been recorded.

The source 24 and the detector 25 is placed facing each other with a spacing 26 in-between. The spacing 26 is made just as big as to fit the receiving element 22. When a bottle 21 containing beer is to be analyzed it is placed in the receiving element 22 and is thereby placed between the source 24 and the detector 25. This implies that bottles with beer that the producer wants to analyze is taken directly from the production line and placed into the device 20 without opening the bottle 21. A lid may then be applied on the receiving element for blocking any background radiation, which otherwise may disturb the measurements.

Since the bottle 21 is capsuled throughout the entire analysis there is no contact between the beer in the container and the air outside the container. Thus, the container prevails static equilibrium between the beer and the carbon dioxide, which is the pressurizing gas in beer. The source 24 and the detector 25 is arranged for irradiating these kinds of closed containers and beverages and for detecting the transmittance. As a result the beer will not change from the time of analysis until the product reaches a customer.

The detector 25 detects the transmitted radiation as a spectrum indicating the absorbance of the contents of the beer for different wavelengths. The spectrum is used to determine the quality of the beer. The amount of ethyl alcohol, a constituent, is the most commonly used content for determining the quality in the beer. Other parameters that may determine the quality are viscosity, original gravity and colour.

Further, the analyzing means 23 comprises a calculating means 27 that determines the quality of the beer. The quality is determined, as mentioned above, by the parameters and/or the constituents of the beer. The calculation means receives the spectrum from the detector 25. By using univariate or multivariate analysis on the detected spectrum of the absorption of the beer the different parameters and constituents are determined. The calculating means 27 is a data handling device 20 in which univariate or multivariate analysis may be used.

The analyzing means may be controllable through a central user interface (not shown). Hereby, the radiation source 24 may be actively turned on and off for initiating and stopping analyses. Further, the result of the determined quality may be presented to a user through this user interface.

It should be emphasized that the embodiments described herein are in no way limiting and that many alternative embodiments are possible within the scope of protection defined by the appended claims.

For example, the radiation source 24 could be any kind of source, which emits electromagnetic radiation in a range of wavelengths. Preferably, the emitted radiation has a smooth intensity distribution for the different wavelengths but it is not a necessity. Thus the radiation source 24 need not to be a halogen lamp. For example, a xenon flash lamp could be used instead. Instead of a source 24 that irradiates within a range of wavelengths the source 24 may be two lasers or an array of LEDs irradiating in at least two wavelengths within the range mentioned above.

The bottle used for analysis may be a regular bottle produced. Preferably, the analysis is performed before labelling. However, a bottle which is specifically designed for analysis may be used. Then, such a bottle may at regular intervals be fed through the production line and thereafter be taken out for analysis of the beverage inside it. Such a bottle is typically made of uncoloured glass and has even and straight edges. However, it is not necessary to use such a special bottle in order to obtain a reliable analysis result. Use of coloured bottles having rough surfaces due to long-time use may still give reliable analysis result. Also, a reference bottle may be used occasionally for the purpose of calibration of the device.

What is claimed is:

1. A method for spectrophotometric analysis of a beverage, comprising the step of analyzing the beverage while contained in a closed end-consumer container.

2. The method according to claim 1, wherein the step of analyzing the beverage comprises analyzing said beverage in the closed container while the closed container prevails a static equilibrium between a liquid phase and a gaseous phase.

3. The method according to claim 1, wherein the step of analyzing the beverage comprises analyzing said beverage in the closed container which holds a pressurizing gas.

4. The method according to claim 1, wherein the step of analyzing the beverage comprises detecting electromagnetic radiation which has been transmitted through the beverage.

5. The method according to claim 4, wherein the step of analyzing the beverage comprises irradiating electromagnetic radiation through the beverage.

6. The method according to claim 1, wherein the step of analyzing the beverage comprises detecting electromagnetic radiation which has been transmitted through said closed container and the beverage therein.

7. The method according to claim 6, wherein the step of analyzing the beverage comprises irradiating electromagnetic radiation through said closed container and the beverage therein.

8. The method according to claim 1, wherein the step of analyzing the beverage comprises determining an amount of at least one of the constituents of said beverage.

9. The method according to claim 8, wherein a constituent for which an amount is to be determined is ethyl alcohol.

10. The method according to claim 1, wherein the step of analyzing the beverage comprises determining at least one quality parameter.

11. The method according to claim 10, wherein the quality parameter is at least one in the group of viscosity, original gravity and colour.

12. The method according to claim 1, wherein a bottle is used as said closed container.

13. The method according to claim 4, wherein wavelengths of the electromagnetic radiation used in the step of analyzing is within the range of 400 to 2500 nm.

14. The method according to claim 4, wherein wavelengths of the electromagnetic radiation used in the step of analyzing is within the range of 850 to 1050 nm.

15. The method according to claim 1, wherein the beverage analyzed is beer.

16. The method according to claim 1, wherein said closed container used in the step of analyzing is formed of a material essentially transparent for electromagnetic radiation having wavelengths within the range of 400 to 2500 nm.

17. The method according to claim 1, wherein said closed container used in the step of analyzing is formed of a material essentially transparent for electromagnetic radiation having wavelengths within the range of 850 to 1050 nm.

18. A device for analyzing a beverage, comprising an analyzing means for analyzing the beverage while contained in a closed end consumer container, said analyzing means comprising a detector arranged for detecting electromagnetic radiation which has been transmitted through the beverage.

19. The device according to claim 18, wherein said analyzing means comprises an electromagnetic radiation source arranged for irradiating through the beverage.

20. The device according to claim 18, wherein said detector is arranged for detecting electromagnetic radiation which has been transmitted through said closed container and the beverage therein.

21. The device according to claim 20, wherein said analyzing means comprises an electromagnetic radiation source arranged for irradiating through said closed container and the beverage therein.

22. The device according to claim 21, wherein said electromagnetic radiation source emits radiation having wavelengths within the range of 400 to 2500 nm.

23. The device according to claim 21, wherein said electromagnetic radiation source emits radiation having wavelengths within the range of 850 to 1050 nm.

24. The device according to claim 21, wherein said device is arranged in such a manner that said closed container is placeable between the radiation source and the detector for analyzing the beverage in said closed container.

25. The device according to claim 24, further comprising a receiving element arranged for receiving said closed container.

26. The device according to claim 25, wherein a bottle is used as said closed container and wherein said receiving element is arranged for receiving said bottle.

27. The device according to claim 18, wherein the analyzing means is arranged for analyzing the beverage while contained in said closed container while said closed container prevails a static equilibrium between a liquid phase and a gaseous phase.

28. The device according to claim 18, wherein the analyzing means is arranged for analyzing the beverage while contained in said closed container which holds pressurizing gas.

29. The device according to claim 18, wherein the analyzing means is arranged for determining an amount of at least one of the constituents of said beverage.

30. The device according to claim 29, wherein one of the constituents of the beverage is ethyl alcohol.

31. The device according to claim 18, wherein the analyzing means is arranged for determining at least one quality parameter of the beverage.

32. The device according to claim 31, wherein the quality parameter is at least one in the group of viscosity, original gravity and colour.

33. The device according to claim 18, wherein the beverage is beer.

34. The device according to claim 21, wherein said electromagnetic source emits electromagnetic radiation having wavelengths for which the material of said closed container is essentially transparent.

35. The method according to claim 2, wherein the step of analyzing the beverage comprises analyzing said beverage in the closed container which holds a pressurizing gas.

36. The method according to claim 5, wherein wavelengths of the electromagnetic radiation used in the step of analyzing is within the range of 400 to 2500 nm.

37. The method according to claim 5, wherein wavelengths of the electromagnetic radiation used in the step of analyzing is within the range of 850 to 1050 nm.

38. The method according to claim 4, wherein wavelengths of the electromagnetic radiation used in the step of analyzing is within the range of 400 to 2500 nm.

39. The method according to claim 6, wherein wavelengths of the electromagnetic radiation used in the step of analyzing is within the range of 850 to 1050 nm.

40. The method according to claim 4, wherein wavelengths of the electromagnetic radiation used in the step of analyzing is within the range of 400 to 2500 nm.

41. The method according to claim 6, wherein wavelengths of the electromagnetic radiation used in the step of analyzing is within the range of 850 to 1050 nm.

42. The method according to claim 7, wherein wavelengths of the electromagnetic radiation used in the step of analyzing is within the range of 400 to 2500 nm.

43. The method according to claim 7, wherein wavelengths of the electromagnetic radiation used in the step of analyzing is within the range of 850 to 1050 nm.

44. The device according to claim 19, wherein said detector is arranged for detecting electromagnetic radiation which has been transmitted through said closed container and the beverage therein.
